(19) United States
(12) Patent Application Publication
(10) Pub. No.: US 2026/0290389 A1
(43) Pub. Date: Sep. 24, 2026

(54) Orthogonal Reading Using SOT-Based Readers or Mixed Readers in Vector Magnetic Recording

(71) Applicant: Western Digital Technologies, Inc., San Jose, CA (US)

(72) Inventors: Quang LE, San Jose, CA (US); Xiaoyong LIU, San Jose, CA (US); Maki MAEDA, Fujisawa-shi (JP); Son T. LE, San Jose, CA (US); Hassan OSMAN, San Jose, CA (US); Hisashi TAKANO, Fujisawa-shi (JP)

(73) Assignee: Western Digital Technologies, Inc., San Jose, CA (US)

(21) Appl. No.: 19/088,400

(22) Filed: Mar. 24, 2025

(51) Int. Cl. G11B 5/48

(52) U.S. Cl. CPC G11B 5/4886

(57) ABSTRACT

The present disclosure generally relates to a magnetic recording drive comprising a magnetic recording head having a read head. The read head comprises a first reader and a second reader, where the first reader is configured to read in-plane magnetic fields from a magnetic recording medium, and the second reader is configured to read out-of-plane fields from the medium. The first and second read heads are different. The read head is configured to perform vector reading. In one embodiment, both the first and second readers are single free layer (SFL) readers, where the first reader comprises soft bias side shields and the second reader comprises a rear hard bias structure. In another embodiment, the first reader comprises a dual free layer structure and the second reader comprises a SFL. In yet another embodiment, the second reader comprises a spin orbit torque layer while the first reader does not.

### BACKGROUND OF THE DISCLOSURE

### Field of the Disclosure

Embodiments of the present disclosure generally relate to a magnetic recording drive comprising a magnetic recording head having a read head.

### Description of the Related Art

At the heart of a computer is a magnetic disk drive. Information is written to and read from a disk as the disk rotates past read and write heads that are positioned very close to the magnetic surface of the disk. There have been various read head designs proposed to reduce the physical size of read heads in order to be able to read smaller or more bits of data. Though simply reducing a physical width of a read head cannot sustain the reasonable signal-to-noise ratio (SNR) capability required for higher hard disk drive (HDD) areal density.

Recently, there has been a concept of so-called “double data reading” or “vector reading” to get both in-phase and out-of-phase information from two adjacent tracks on a magnetic recording media using two or more complementary read heads or readers. The information from both tracks is then decoded simultaneously. Utilizing two readers for vector reading allows an increase of the physical width of the read head, resulting in lower head magnetic resistor resistance (MRR) and noise.

Therefore, there is a need in the art for a read head structure capable of performing vector reading without decreasing the size of the read head and hence maintaining a strong SNR.

### SUMMARY OF THE DISCLOSURE

The present disclosure generally relates to a magnetic recording drive comprising a magnetic recording head having a read head. The read head comprises a first reader and a second reader, where the first reader is configured to read in-plane magnetic fields from a magnetic recording medium across two adjacent tracks, and the second reader is configured to read out-of-plane fields in adjacent tracks from the medium. The first and second read heads are different. The read head is configured to perform vector reading. In one embodiment, both the first and second readers are single free layer (SFL) readers, where the first reader comprises soft bias side shields and the second reader comprises a rear hard bias structure. In another embodiment, the first reader comprises a dual free layer structure and the second reader comprises a SFL. In yet another embodiment, the second reader comprises a spin orbit torque layer while the first reader does not.

In one embodiment, a read head comprises a first sensor, the first sensor being one of: (A) a first reader comprising: a first spin orbit torque (SOT) layer disposed at a media facing surface (MFS), a free layer disposed on the SOT layer, and soft bias (SB) side shields disposed adjacent to the free layer on the SOT layer at the MFS; (B) a second reader comprising: a dual free layer (DFL) structure disposed over a shield, synthetic anti-ferromagnetic (SAF) side shields disposed adjacent to the DFL structure on the shield at the MFS, and an anti-ferromagnetic (AFM) layer disposed over the DFL structure and SAF side shields; or (C) a third reader comprising: a first AFM layer, a first anti-parallel (AP) layer disposed on the first AFM layer, a second AP layer disposed over the first AP layer, a free layer disposed over the second AP layer, and SB side shields disposed adjacent to the free layer at the MFS; and a second sensor, comprising: a SOT layer, a free layer disposed on the SOT layer, and a rear hard bias (RHB) structure disposed adjacent to the free layer, the RHB structure being recessed from the MFS.

In another embodiment, a read head comprises a first sensor, the first sensor being one of: (A) a first reader comprising: a dual free layer (DFL) structure disposed over a shield, synthetic anti-ferromagnetic (SAF) side shields disposed adjacent to the DFL structure on the shield at the MFS, and an anti-ferromagnetic (AFM) layer disposed over the DFL structure and SAF side shields; or (B) a second reader comprising: a first AFM layer, a first anti-parallel (AP) layer disposed on the first AFM layer, a second AP layer disposed over the first AP layer, a free layer disposed over the second AP layer, and SB side shields disposed adjacent to the free layer at the MFS; and a second sensor comprising: a first AFM layer, a first anti-parallel (AP) layer disposed on the first AFM layer, a second AP layer disposed over the first AP layer, a free layer disposed over the second AP layer, and a RHB structure disposed adjacent to the free layer, the RHB structure being recessed from the MFS.

In yet another embodiment, a read head comprises a first sensor, the first sensor being one of: (A) a first reader comprising: a dual free layer (DFL) structure disposed over a shield, synthetic anti-ferromagnetic (SAF) side shields disposed adjacent to the DFL structure on the shield at the MFS, and an anti-ferromagnetic (AFM) layer disposed over the DFL structure and SAF side shields; or (B) a second reader comprising: a first AFM layer, a first anti-parallel (AP) layer disposed on the first AFM layer, a second AP layer disposed over the first AP layer, a free layer disposed over the second AP layer, and SB side shields disposed adjacent to the free layer at the MFS; and a second sensor comprising: a first AFM layer, a first anti-parallel (AP) layer disposed on the first AFM layer, a second AP layer disposed over the first AP layer, a free layer disposed over the second AP layer, a RHB structure disposed adjacent to the free layer, the RHB structure being recessed from the MFS, and a shield notch.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic illustration of certain embodiments of a magnetic media drive including a magnetic recording head.

FIG. 2 is a fragmented, cross-sectional side view of certain embodiments of a read/write head.

FIG. 3A illustrates a first sensor and a second sensor of a read head disposed over two adjacent tracks performing vector reading, according to one embodiment.

FIG. 3B illustrates a table showing the performance and results of the vector reading, according to one embodiment.

FIGS. 4A-4B illustrate a read head, according to one embodiment.

FIG. 4C illustrates a MFS view of a read head, according to another embodiment.

FIGS. 5A-5B illustrate a read head, according to another embodiment.

FIGS. 6A-6B illustrate a read head, according to yet another embodiment.

FIG. 6C illustrates a cross-sectional view of a read head, according to another embodiment.

FIGS. 7A-7B illustrate a read head, according to yet another embodiment.

FIG. 7C illustrates a cross-sectional view of a read head, according to another embodiment.

FIGS. 8A-8B illustrate a read head, according to yet another embodiment.

FIG. 8C illustrates a cross-sectional view of a read head, according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to a magnetic recording drive comprising a magnetic recording head having a read head. The read head comprises a first reader and a second reader, where the first reader is configured to read in-plane magnetic fields from a magnetic recording medium, and the second reader is configured to read out-of-plane fields from the medium. The first and second read heads are different. The read head is configured to perform vector reading. In one embodiment, both the first and second readers are single free layer (SFL) readers, where the first reader comprises soft bias side shields and the second reader comprises a rear hard bias structure. In another embodiment, the first reader comprises a dual free layer structure and the second reader comprises a SFL. In yet another embodiment, the second reader comprises a spin orbit torque layer while the first reader does not.

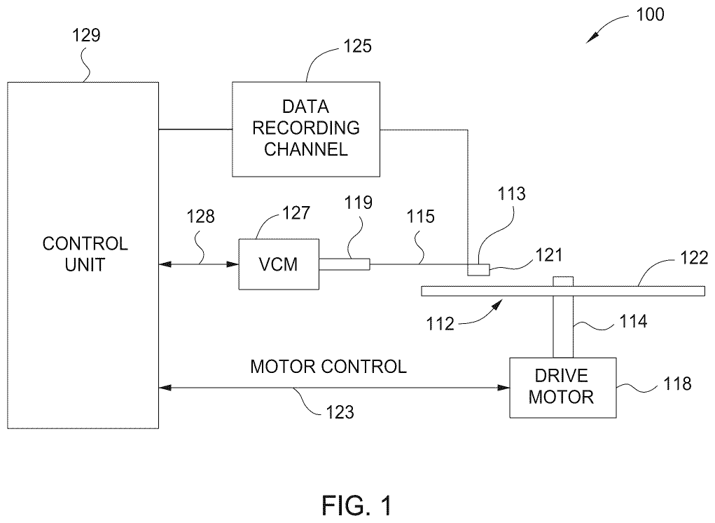

FIG. 1 is a schematic illustration of certain embodiments of a magnetic media drive 100 including a magnetic recording head having a SOT MTJ device. Such a magnetic media drive may be a single drive or comprise multiple drives. For the sake of illustration, a single disk drive 100 is shown according to certain embodiments. As shown, at least one rotatable magnetic disk 112 is supported on a spindle 114 and rotated by a drive motor 118. The magnetic recording on each magnetic disk 112 is in the form of any suitable patterns of data tracks, such as annular patterns of concentric data tracks (not shown) on the magnetic disk 112.

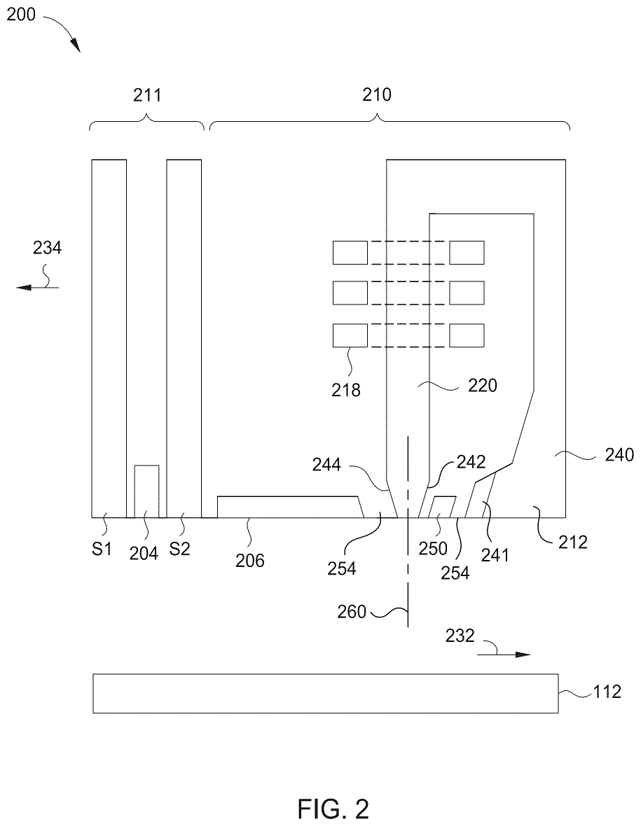

At least one slider 113 is positioned near the magnetic disk 112, each slider 113 supporting one or more magnetic head assemblies 121 that include a SOT device. As the magnetic disk 112 rotates, the slider 113 moves radially in and out over the disk surface 122 so that the magnetic head assembly 121 may access different tracks of the magnetic disk 112 where desired data are written. Each slider 113 is attached to an actuator arm 119 by way of a suspension 115. The suspension 115 provides a slight spring force which biases the slider 113 toward the disk surface 122. Each actuator arm 119 is attached to an actuator means 127. The actuator means 127 as shown in FIG. 2 may be a voice coil motor (VCM). The VCM includes a coil movable within a fixed magnetic field, the direction and speed of the coil movements being controlled by the motor current signals supplied by control unit 129.

During operation of the disk drive 100, the rotation of the magnetic disk 112 generates an air bearing between the slider 113 and the disk surface 122 which exerts an upward force or lift on the slider 113. The air bearing thus counter-balances the slight spring force of suspension 115 and supports slider 113 off and slightly above the disk surface 122 by a small, substantially constant spacing during normal operation.

The various components of the disk drive 100 are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads on the assembly 121 by way of recording channel 125.

The above description of a typical magnetic media drive and the accompanying illustration of FIG. 1 are for representation purposes only. It should be apparent that magnetic media drives may contain a large number of media, or disks, and actuators, and each actuator may support a number of sliders.

It is to be understood that the embodiments discussed herein are applicable to a data storage device such as a hard disk drive (HDD) as well as a tape drive such as a tape embedded drive (TED) or an insertable tape media drive. An example TED is described in co-pending patent application titled “Tape Embedded Drive,” U.S. application Ser. No. 16/365,034, filed Mar. 31, 2019, assigned to the same assignee of this application, which is herein incorporated by reference. As such, any reference in the detailed description to an HDD or tape drive is merely for exemplification purposes and is not intended to limit the disclosure unless explicitly claimed. For example, references to disk media in an HDD embodiment are provided as examples only, and can be substituted with tape media in a tape drive embodiment. Furthermore, reference to or claims directed to magnetic recording devices or data storage devices are intended to include at least both HDD and tape drive unless HDD or tape drive devices are explicitly claimed. In addition, the various embodiments disclosed herein may be used as part of magnetic field sensors generally, outside of the magnetic sensing application in data storage devices.

FIG. 2 is a fragmented, cross-sectional side view of certain embodiments of a read/write head 200 having a SOT device. The read/write head 200 faces a magnetic media 112. The read/write head 200 may correspond to the magnetic head assembly 121 described in FIG. 1. The read/write head 200 includes a media facing surface (MFS) 212, such as a gas bearing surface, facing the disk 112, a write head 210, and a magnetic read head 211. As shown in FIG. 2, the magnetic media 112 moves past the write head 210 in the direction indicated by the arrow 232 and the read/write head 200 moves in the direction indicated by the arrow 234.

In some embodiments, the magnetic read head 211 is a magnetoresistive (MR) read head that includes an MR sensing element 204 located between MR shields S1 and S2. In other embodiments, the magnetic read head 211 is a magnetic tunnel junction (MTJ) read head that includes a MTJ sensing device 204 located between MR shields S1 and S2. The magnetic fields of the adjacent magnetized regions in the magnetic disk 112 are detectable by the MR (or MTJ) sensing element 204 as the recorded bits.

The write head 210 includes a main pole 220, a leading shield 206, a trailing shield 240, an optional spin orbital torque (SOT) device 250, and a coil 218 that excites the main pole 220. The coil 218 may have a “pancake” structure which winds around a back-contact between the main pole 220 and the trailing shield 240, instead of a “helical” structure shown in FIG. 2. When included, e.g., to achieve a Microwave Assisted Magnetic Recording (MAMR) effect, the SOT device 250 is formed in a gap 254 between the main pole 220 and the trailing shield 240. The main pole 220 includes a trailing taper 242 and a leading taper 244. The trailing taper 242 extends from a location recessed from the MFS 212 to the MFS 212. The leading taper 244 extends from a location recessed from the MFS 212 to the MFS 212. The trailing taper 242 and the leading taper 244 may have the same degree of taper, and the degree of taper is measured with respect to a longitudinal axis 260 of the main pole 220. In some embodiments, the main pole 220 does not include the trailing taper 242 and the leading taper 244. Instead, the main pole 220 includes a trailing side (not shown) and a leading side (not shown), and the trailing side and the leading side are substantially parallel. The main pole 220 may be a magnetic material, such as a FeCo alloy. The leading shield 206 and the trailing shield 240 may be a magnetic material, such as a NiFe alloy. In certain embodiments, the trailing shield 240 can include a trailing shield hot seed layer 241. The trailing shield hot seed layer 241 can include a high moment sputter material, such as CoFeN, FeXN, or FeX, where X includes at least one of N, Al, Ni, Co, Ta, Re, Ir, Pt, Rh, Ta, Zr, and Ti. In certain embodiments, the trailing shield 240 does not include a trailing shield hot seed layer.

In other embodiments, instead of an SOT device 250 it may be a conductive stack in the write gap. In certain embodiments, the read/write head 200 additionally includes mechanisms (not shown) for supporting Heat Assisted Magnetic Recording (HAMR), which may include a waveguide coupled to a light source and a near field transducer (NFT) placed adjacent to the main pole 220 and coupled to the waveguide to convert the delivered light into a heating spot on the media.

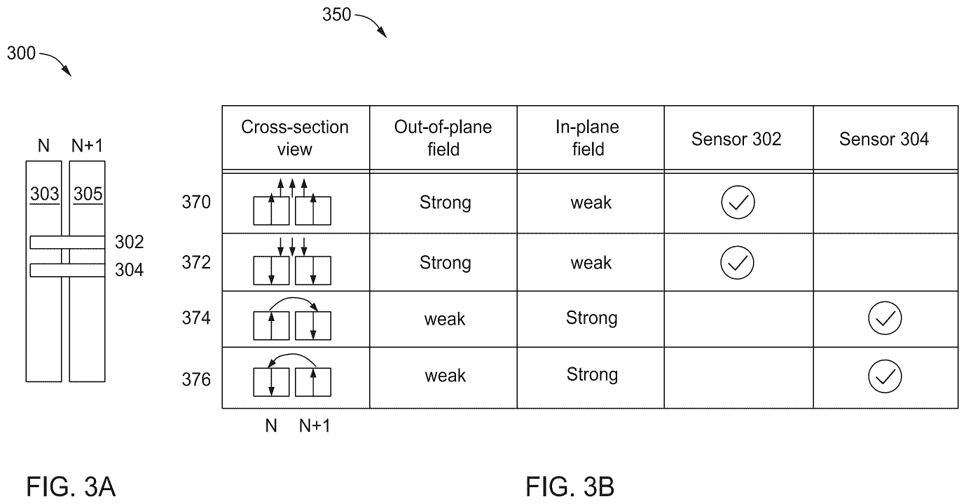

FIG. 3A illustrates a first reader 302 and a second reader 304 of a read head disposed over two adjacent tracks 303, 305 performing vector reading, according to one embodiment. FIG. 3B illustrates a table 350 showing the concept of orthogonal reading for vector recording, according to one embodiment.

As shown in FIG. 3A, the first and second sensors or readers 302, 304 are disposed over two data tracks 303, 305. The first and second readers 302, 304 read bits from both tracks simultaneously. The width of the first and second readers are generally larger the width of tracks. As shown, the first reader 302 is capable of reading out-of-plane magnetic fields, and the second reader 304 is capable of reading in-plane magnetic fields.

The table 350 of FIG. 3B shows the possible results from both readers 302, 304. In row 370, the bit read from the first data track 303 (N) is up (e.g., 0), and the bit orientation from the second data track 305 (N+1) is up (e.g., 0). In row 372, the bit read from the first data track 303 (N) is down (e.g., 1), and the bit from the second data track 305 (N+1) is down (e.g., 1). When both bits read from the two tracks 303, 305 are the same, the field is out-of-plane or in-phase, and the first reader 302 has a strong detection while the second reader 304 has a weak detection.

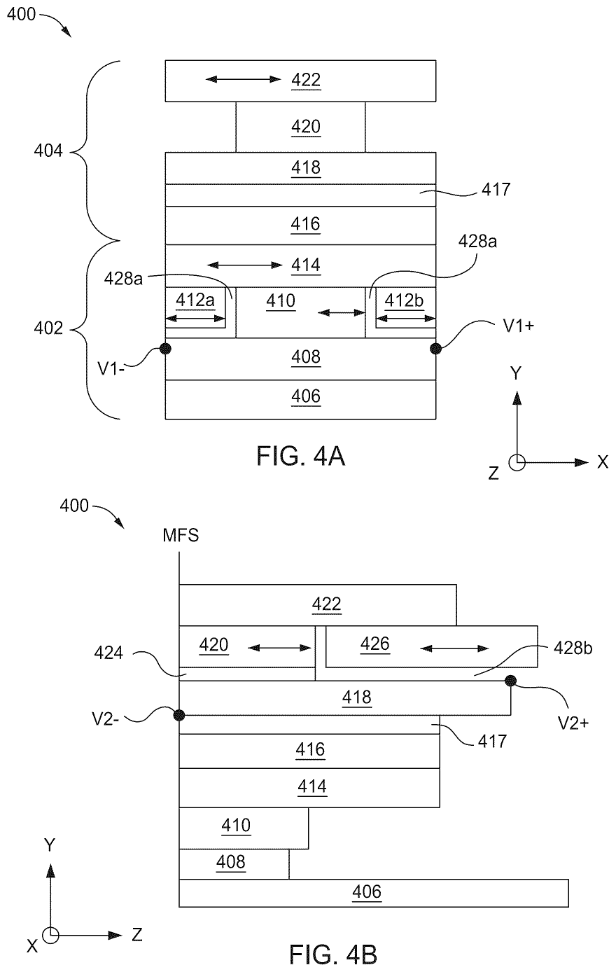

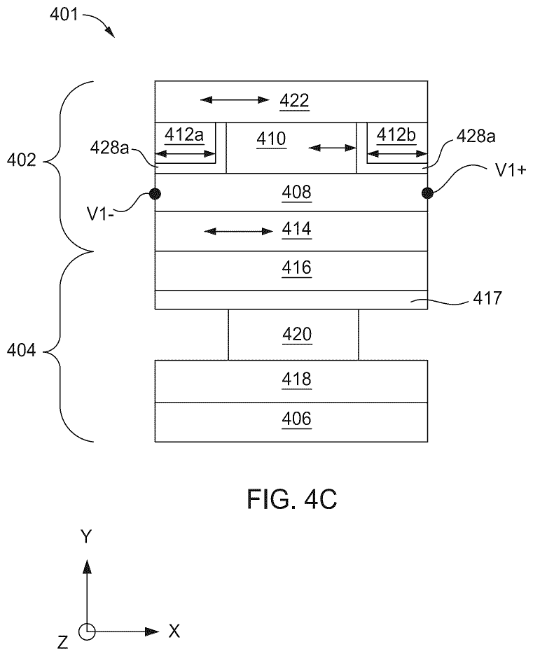

In row 374, the bit read from the first data track 303 (N) is up (e.g., 0), and the bit from the second data track 305 (N+1) is down (e.g., 1). In row 376, the bit read from the first data track 303 (N) is down (e.g., 1), and the bit from the second data track 305 (N+1) is up (e.g., 0). When the bits of the two tracks 303, 305 are opposite, the net stray field coming from those bits from the two tracks is in-plane or off-phase, and the second reader 304 has a strong detection while the first reader 302 has a weak detection. Thus, a read head comprising both the first reader 302 and the second reader 304 is able to read both in-plane magnetic fields and out-of-plane magnetic fields, and decode information from both tracks simultaneously. FIGS. 4A-8C below show read heads 400, 401, 500, 600, 601, 700, 701, 800, 801 capable of performing orthogonal reading without reducing the overall size of the read head.

FIGS. 4A-4B illustrate a read head 400, according to one embodiment. FIG. 4A illustrates a media facing surface (MFS) view, and FIG. 4B illustrates a cross-sectional side view. The read head 400 may be a part of the magnetic media drive 100 of FIG. 1. The read head 400 may be a part of the read/write head 200 of FIG. 2, such as the read head 211. The read head 400 may be the read head described in FIGS. 3A-3B.

The read head 400 comprises a first spin orbit torque (SOT) reader 402 and a second SOT reader 404 disposed over the first reader 402. As used herein, the terms “sensor” and “reader” as interchangeable. The first reader 402 comprises a first or lower shield 406, a first SOT layer 408 disposed on the first shield 406, a first free layer 410 disposed on the first SOT layer 408, and a second or middle shield 414 disposed over the first free layer 410. Soft bias (SB) side shields 412a, 412b are disposed adjacent to the free layer 410 between the first SOT layer 408 and the second shield 414. The SB side shields 412a, 412b are coupled to the second shield 414 along the down-track direction (i.e., the y-direction). Insulation layers 428a may be disposed between the SB side shields 412a, 412b and the first free layer 410, between the SB side shields 412a, 412b and the first SOT layer 408. The first SOT layer 408 may have a stripe height in the z-direction greater than, equal to, or less than a stripe height of the first free layer 410. Other layers, such as a buffer layer, interlayer, and cap layer, are not shown for simplicity.

The first free layer 410, the second shield 414, and the SB side shields 412a, 412b have parallel magnetization directions. A first negative voltage lead (V1−) is coupled to the first SOT layer 408 below a first SB side shield 412a, and a first positive voltage lead (V1+) is coupled to the first SOT layer 408 below a second SB side shield 412b. The voltage reading between V1+ and V1− from the first reader 402 detects the out-of-plane (z-direction) field component from data tracks like conventional perpendicular recording (PMR).

The second reader 404 comprises a read separation gap (RSG) 416, an optional middle shield 417, a second SOT layer 418 disposed over the middle shield 417, a second free layer 420 disposed on the second SOT layer 418, and a fourth or upper shield 422 disposed on the second free layer 420. An optional interlayer 424 may be disposed between the second SOT layer 418 and the second free layer 420, like shown in FIG. 4B. In some embodiments, a second optional interlayer (not shown) is disposed between the first SOT layer 408 and the lower shield 406. Other layers, such as a buffer layer, interlayer, and cap layer, are not shown for simplicity. The second reader 404 does not comprise SB side shields. However, as shown in FIG. 4B, a rear hard bias (RHB) structure 426 is disposed adjacent to the second free layer 420 recessed from the MFS. Insulation layers 428b may be disposed between the second free layer 420 and the RBH structure 426, and/or between the second free layer 420 and the third shield 422. The RHB 426 is also separated from the top shield 422 by an insulator (not shown). The second free layer 418 may have a stripe height in the z-direction greater than or equal to a stripe height of the first free layer 410.

Each of the first, second, third, and fourth shields 406, 414, 417, 422 may have an optional AFM with or without AFC structure included such that they all have a parallel magnetization direction along the cross-track direction (the x-direction or the −x-direction). The magnetization direction of the first free layer 410 is perpendicular to the magnetization direction of the second free layer 420. A second negative voltage lead (V2−) is coupled to the second SOT layer 418 at the MFS, and a second positive voltage lead (V2+) is coupled to the second SOT layer 418 below the RHB structure 426. The voltage reading between V2+ and V2− from the second reader 404 detects the in-plane (x-direction) component from data tracks.

The first reader 402 and the second reader 404 are two readers using different technologies. The first reader 402 is based on the inverse spin Hall effect (iSHE), where the first free layer 410 is biased by the SB side shields 412a, 412b. The first reader 402 detects out-of-plane field (i.e., out of the magnetic disk plane) or the in-phase reading. The second reader 404 is also based on iSHE, where the second free layer 420 is biased by the RHB structure 426. The second reader 404 detects in the in-plane field (i.e., parallel to the magnetic media) of the off-phase reading. Thus, the read head 400 can read both out-of-plane and in-plane magnetic fields.

FIG. 4C illustrates a MFS view of a read head 401, according to another embodiment. The read head 401 may be a part of the magnetic media drive 100 of FIG. 1. The read head 401 may be a part of the read/write head 200 of FIG. 2, such as the read head 211. The read head 401 may be the read head described in FIGS. 3A-3B.

The read head 401 is similar to the read head 400 of FIGS. 4A-4B; however, the first reader 402 is disposed over the second reader 404. As such, the second SOT layer 418 is disposed on the first shield 406, and the first free layer 410 is disposed adjacent to the third shield 422.

The first, second, third, and fourth shields 406, 414, 417, 422 may each individually comprise of any of the well-known materials used for conventional magnetic shields, for example, NiFe alloys wherein Ni is present in the NiFe alloy in an amount greater than about between 40 atomic percent. Alternatively, other soft ferromagnetic materials may be used, like NiFeCr, NiFeMo, CoZrTa, CoZrNb and CoFeZr alloys, and soft materials such as NiFe or NiFeCr, and may have an optional AFM with or without AFC structure included to improve shield stability (not shown). The first and second SOT layers 408, 418 may each individually comprise doped or undoped BiSb, doped or undoped YPtBi, FeSi, CoSi, or other materials with a stronger SOT effect. The first and second free layers 410, 420 may each individually comprise NiFe, CoFe, CoFeB, CoHf, CoB, or combinations thereof. The SB side shields 412a, 412b may each individually comprise NiFe, CoFe, or combinations thereof. The RHB structure 426 may comprise CoPt, FePt, CoFe, NiFe, or combinations thereof. The optional interlayer 424 may comprise NiFeGe/MgO, for example. The RSG 416 may comprise a non-magnetic electrically insulating barrier layer like TiO₂, MgO, Al₂O₃, SiO₂, SiN, etc.

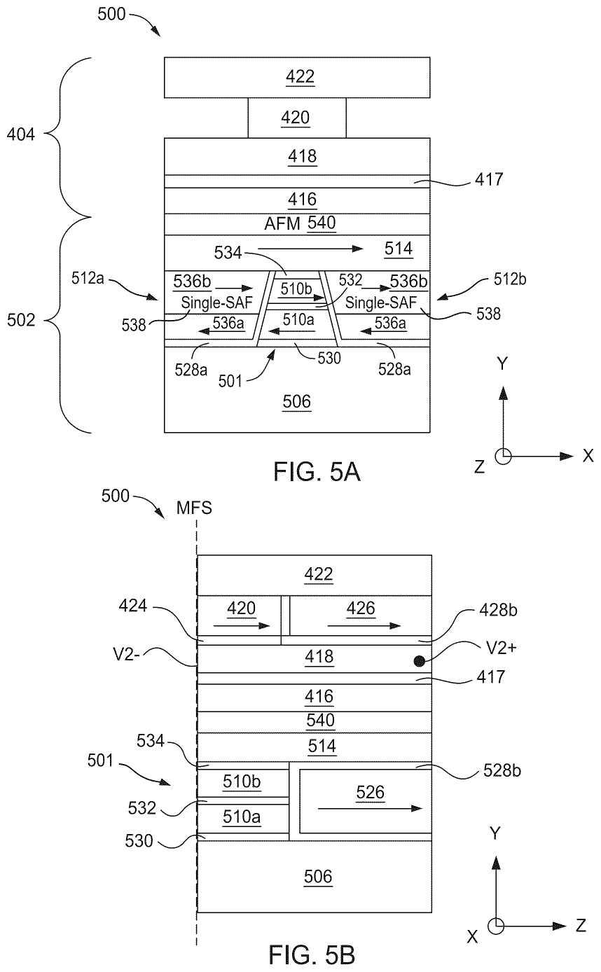

FIGS. 5A-5B illustrate a read head 500, according to another embodiment. FIG. 5A illustrates a MFS view, and FIG. 5B illustrates a cross-sectional side view. The read head 500 may be a part of the magnetic media drive 100 of FIG. 1. The read head 500 may be a part of the read/write head 200 of FIG. 2, such as the read head 211. The read head 500 may be the read head described in FIGS. 3A-3B.

The read head 500 comprises a first reader 502 and the second SOT reader 404 of FIGS. 4A-4B disposed on the first reader 502. The first reader 502 is a dual free layer (DFL) reader comprising a DFL structure 501. The first reader 502 comprises a first shield 506, the DFL structure 501 disposed on the first shield 506, a second shield 514 disposed over the DFL structure 501, and an anti-ferromagnetic (AFM) layer 540 is disposed on the second shield 514. The AFM layer 540 may be considered a part of the second shield 514, and is optional. The DFL structure 501 comprises a seed layer 530 disposed on the first shield 506, a first free layer 510a disposed on the seed layer 530, a barrier layer 532 disposed on the first free layer 510a, a second free layer 510b disposed on the barrier layer 532, and a cap layer 534 disposed on the second free layer 510b. As shown in FIG. 5B, a RHB structure 526 is disposed adjacent to the first and second free layers 510a, 510b recessed from the MFS. An insulating layer 528b is disposed between the DFL structure 501 and the RHB structure 526. The RHB structure 526 and the RHB structure 426 have parallel magnetization directions (i.e., in the z-direction).

In the first reader 502, the first free layer 510a and the second free layer 510b have a finite angle, pointing towards the RHB structure 526 due to a combination effect coming from the side shield 536 and the RHB structure 526. The free layer 420 of the second reader 404 has a perpendicular magnetization direction to the MFS (along the z-direction).

Synthetic anti-ferromagnetic (SAF) side shield structures 512a, 512b are disposed on either side of the DFL structure 501 between the first shield 506 and the second shield 514. Each SAF side shield structure 512a, 512b comprises a first SB layer 536a, a spacer layer 538 disposed on the first SB layer 536a, and a second SB layer 536b disposed on the spacer layer 538. The second SB layers 536b and the second shield 514 have a parallel magnetization direction (i.e., in the x-direction). The second free layer 510 has a canted magnetization direction towards the x-direction and the z-direction. An insulating layer 528a is disposed between the DFL structure 501 and the SAF side shield structures 512a, 512b.

The first reader 502 and the second reader 404 are two readers using different technologies. The DFL structure 501 is biased by the SAF side shields 512a, 512b longitudinally and by the RHB structure 526 vertically for perpendicular or out-of-plane field detection. The second reader 404 is based on iSHE, where the second free layer 420 is biased by the RHB structure 426 vertically. The second reader 404 detects in the in-plane field (i.e., parallel to the magnetic media) for the off-phase reading. Thus, the read head 500 can read both out-of-plane and in-plane magnetic fields. While not shown, the first reader 502 may be disposed over the second reader 404, like the read head 301 of FIG. 4C.

The first and second free layers 510a, 510b may each comprise NiFe, CoFe, CoFeB, CoHf, CoB, or combinations thereof. The first and second SB layers 536a, 536b may each comprise NiFe, CoFe, or combinations thereof. The spacer layer 538 may comprise Ru and have a thickness of about 8 Å to about 10 Å. The seed layer 530 may comprise non-magnetic materials, such as Ta, Ru, CoB, CoHf, or others, the barrier layer 532 may comprise MgO or AIOx, where x is a numeral, or other non-magnetic metal materials, such as Cu or Ag, and the cap layer 534 may comprise Ru, Ta, Ti, NiFeGe, CoHf, NiFe, CoFe, or combination thereof. The RHB structure 526 may comprise CoPt, FePt, CoFe, NiFe, or combinations thereof. The RHB structure 526 has shape anisotropy (a long rectangular shape). The second shield 514 may comprise any shield material listed above, and the AFM layer 540 may comprise IrMn, FeMn, PtMn, etc.

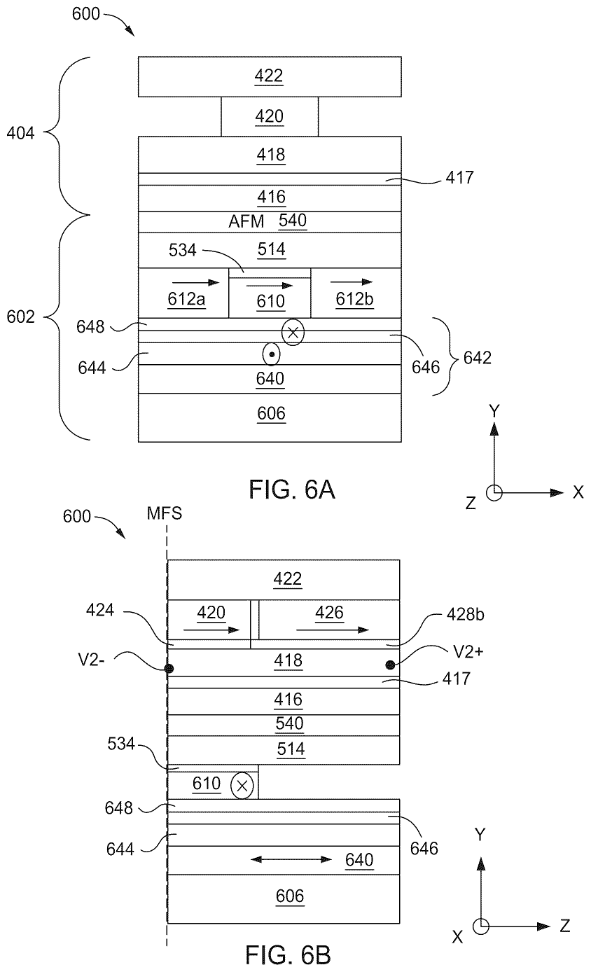

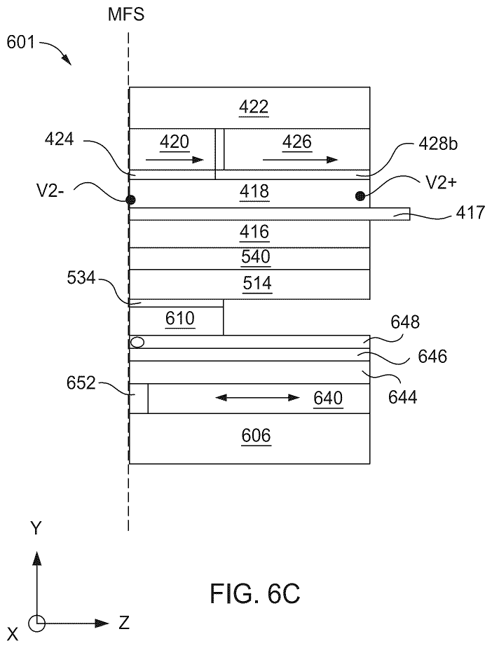

FIGS. 6A-6B illustrate a read head 600, according to yet another embodiment. FIG. 6A illustrates a MFS view, and FIG. 6B illustrates a cross-sectional side view. The read head 600 may be a part of the magnetic media drive 100 of FIG. 1. The read head 600 may be a part of the read/write head 200 of FIG. 2, such as the read head 211. The read head 600 may be the read head described in FIGS. 3A-3B.

The read head 600 comprises a first reader 602 and the second SOT reader 404 of FIGS. 4A-4B disposed on the first reader. The first reader 602 is a single free layer (SFL) reader, and comprises a first shield 606, a pinned structure 642 disposed on the first shield 606, a barrier layer (not shown) disposed on the pinned structure 642, a free layer 610 disposed on the barrier layer, a cap layer 534 disposed on the free layer 610, the second shield 514 disposed over the cap layer 534, and the AFM layer 540 disposed on the second shield 514. SB side shields 612a, 612b are disposed adjacent to the free layer 610 between the first and second shields 606, 514. The free layer 610 and the SB side shields 612a, 612b have a parallel magnetization (e.g., in the x-direction). An insulating layer, such as insulating layer 428a, may be disposed between the free layer 610 and the SB side shields 612a, 612b.

The pinned structure 642 comprises an AFM layer 640, a first anti-parallel (AP) layer 644 disposed on the AFM layer 640, a spacer layer 646 disposed on the first AP layer 644, and a second AP layer 648 disposed on the spacer layer 646. The first AP layer 644 and the second AP layer 648 have anti-parallel magnetizations. For example, the first AP layer 644 has a magnetization in the z-direction, and the second AP layer 648 has a magnetization in the-z-direction.

The magnetization directions of both the first and second AP layers 644, 648 is perpendicular to the magnetization direction of the free layer 610. The free layer 610 of the first sensor 602 has a perpendicular magnetization direction to the free layer 420 of the second sensor 404. The AFM layer 640 has a magnetization direction in the z-direction.

The first reader 602 and the second reader 404 are two readers using different technologies. The free layer 610 is biased by the SB side shields 612a, 612b longitudinally for perpendicular or out-of-plane field detection. The second reader 404 is based on iSHE, where the second free layer 420 is biased by the RHB structure 426. The second reader 404 detects in the in-plane field (i.e., parallel to the magnetic media) for the off-phase reading. Thus, the read head 400 can read both out-of-plane and in-plane magnetic fields. While not shown, the first reader 602 may be disposed over the second reader 404, like the read head 301 of FIG. 4C.

The free layer 610 may comprise any free layer materials listed above, and the SB side shields 612a, 612b may comprise any SB side shield material listed above. The shield layer 642 may comprise any shield material listed above, and the AFM layer 640 may comprise Any AFM material listed above. The first and second AP layers 644, 648 may each comprise NiFe, CoFe, Co, CoB, CoFeB, or combinations thereof, and the spacer layer 646 may comprise Ru.

FIG. 6C illustrates a cross-sectional view of a read head 601, according to another embodiment. The read head 601 may be a part of the magnetic media drive 100 of FIG. 1. The read head 601 may be a part of the read/write head 200 of FIG. 2, such as the read head 211. The read head 601 may be the read head described in FIGS. 3A-3B.

The read head 601 is similar to the read head 600 of FIGS. 6A-6B; however, the AFM layer 640 is recessed from the MFS by a shield notch 652. The shield notch 652 may comprise any shield material listed above, and have a thickness in the z-direction of about 10 nm to about 50 nm.

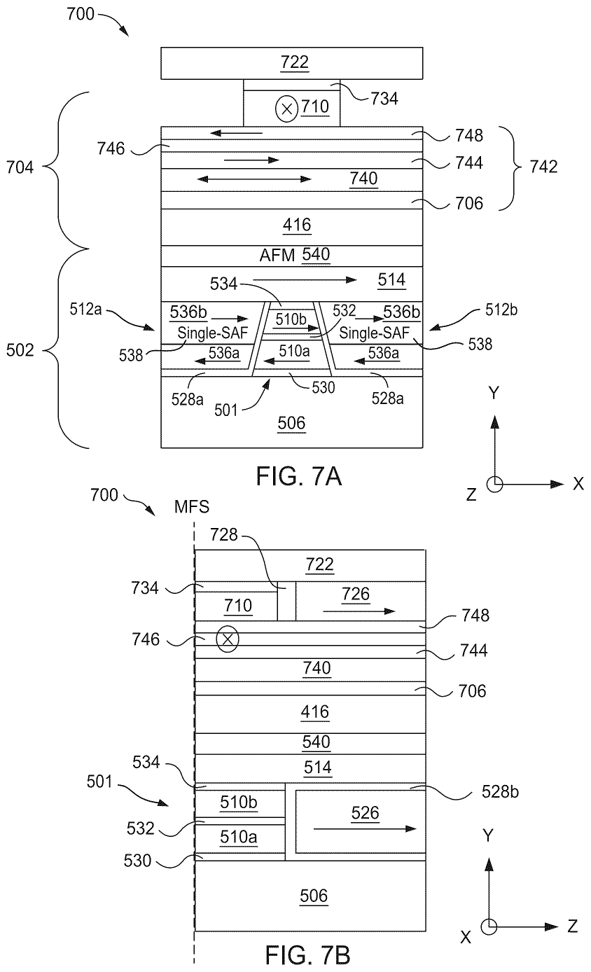

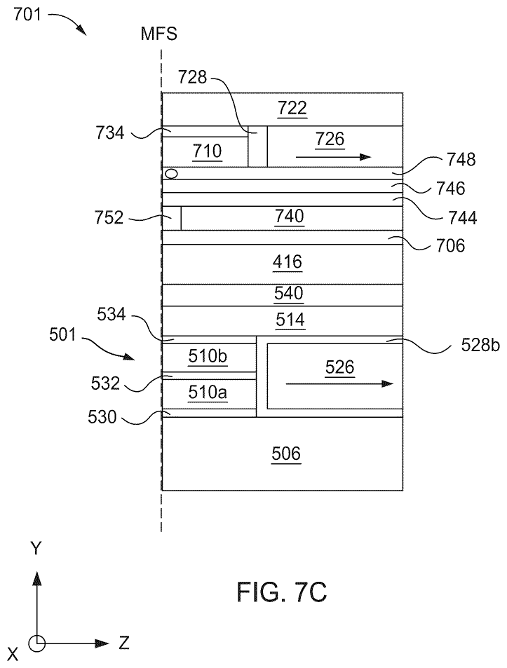

FIGS. 7A-7B illustrate a read head 700, according to yet another embodiment. FIG. 7A illustrates a MFS view, and FIG. 7B illustrates a cross-sectional side view. The read head 700 may be a part of the magnetic media drive 100 of FIG. 1. The read head 700 may be a part of the read/write head 200 of FIG. 2, such as the read head 211. The read head 700 may be the read head described in FIGS. 3A-3B.

The read head 700 comprises the DFL reader 502 of FIGS. 5A-5B and a SFL tunneling magnetoresistance (TMR) or giant magnetoresistance (GMR) reader 704 disposed on the DFL reader 502. The SFL reader 704 comprises the RSG 416, a first shield 706 disposed on the RSG 416, a pinned structure 742 disposed on the first shield 706, a barrier layer (not shown) disposed on the pinned structure 742, a free layer 710 disposed on the barrier layer, a cap layer 734 disposed on the free layer 710, and a fourth shield 722 disposed over the cap layer 734. A RHB structure 726 is disposed adjacent to the free layer 710 recessed from the MFS. An insulating layer 728 is disposed between the free layer 710 and the RHB structure 726.

The free layer 710 has a magnetization direction in the-z-direction. In the DFL reader 502, the first free layer 510a and the second free layer 510b have a finite angle, pointing towards the RHB structure 726.

The pinned structure 742 comprises an AFM layer 740, a first AP layer 744 disposed on the AFM layer 740, a spacer layer 746 disposed on the first AP layer 744, and a second AP layer 748 disposed on the spacer layer 746. The first AP layer 744 and the second AP layer 748 have anti-parallel magnetizations. For example, the first AP layer 744 has a magnetization in the x-direction, and the second AP layer 748 has a magnetization in the-x-direction. The magnetization directions of both the first and second AP layers 744, 748 is perpendicular to the magnetization direction of the free layer 710. The AFM layer 740 has a magnetization in the cross-track direction (i.e., the x-direction and the-x-direction).

The first reader 502 and the second reader 704 are two readers using different technologies. The DFL structure 502 is biased by the SAF side shields 512a, 512b longitudinally and RHB structure 726 vertically for perpendicular or out-of-plane field detection. The second reader 704 utilizes the free layer 710 for in-plane field sensing, as the AFM layer 740 is pinned along the longitudinal or cross-track direction, and the free layer 710 is biased along the transverse direction through the RHB structure 726. Thus, the read head 700 can read both out-of-plane and in-plane magnetic fields. While not shown, the first reader 502 may be disposed over the second reader 704, like the read head 301 of FIG. 4C.

The free layer 710 may comprise any free layer materials listed above, the RHB structure 726 may comprise any RHB structure materials listed above, and the fourth shield 722 and the first shield layer 706 may comprise any shield materials listed above. The AFM layer 740 may comprise Any AFM material listed above. The first and second AP layers 744, 748 may each comprise any AP material listed above, and the spacer layer 646 may comprise Ru. The cap layer 734 may comprise the same materials as the cap layer 534.

FIG. 7C illustrates a cross-sectional view of a read head 701, according to another embodiment. The read head 701 may be a part of the magnetic media drive 100 of FIG. 1. The read head 701 may be a part of the read/write head 200 of FIG. 2, such as the read head 211. The read head 701 may be the read head described in FIGS. 3A-3B.

The read head 701 is similar to the read head 700 of FIGS. 7A-7B; however, the AFM layer 740 is recessed from the MFS by a shield notch 752. The shield notch 752 may comprise any shield material listed above, and have a thickness in the z-direction of about 10 nm to about 50 nm.

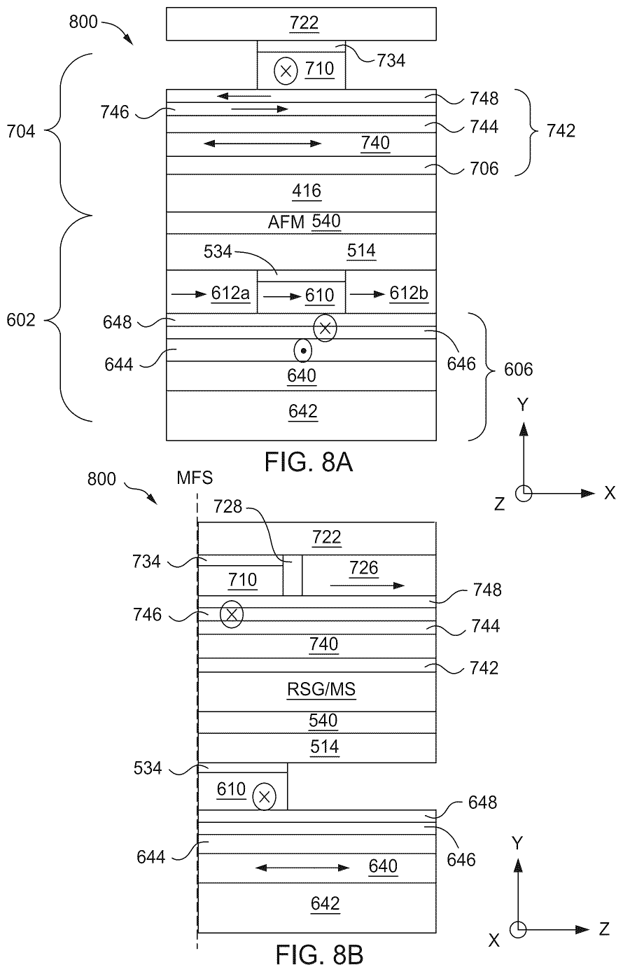

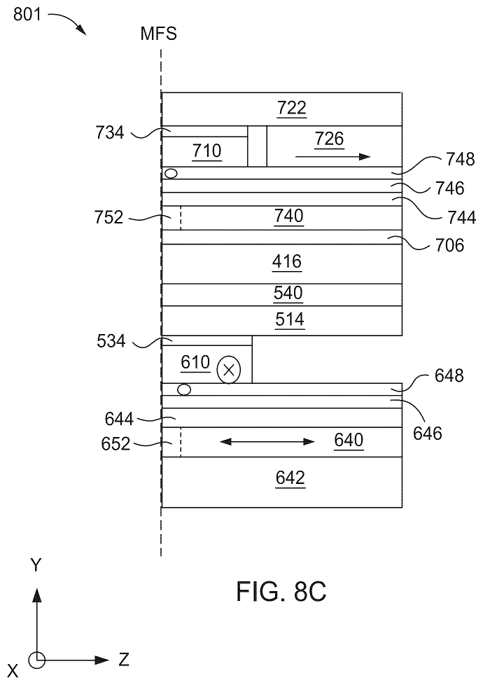

FIGS. 8A-8B illustrate a read head 800, according to another embodiment. FIG. 8A illustrates a MFS view, and FIG. 8B illustrates a cross-sectional side view. The read head 800 may be a part of the magnetic media drive 100 of FIG. 1. The read head 800 may be a part of the read/write head 200 of FIG. 2, such as the read head 211. The read head 800 may be the read head described in FIGS. 3A-3B.

The read head 800 comprises the SFL reader 602 of FIGS. 6A-6B, and the SFL reader 704 of FIGS. 7A-7C. As such, the first and second AP layers 644, 648 of the SFL reader 602 have anti-parallel magnetization directions, and the first and second AP layers 744, 748 of the SFL TMR reader 704 have anti-parallel magnetization directions, where the magnetization directions of the first and second AP layers 644, 648 of the SFL reader 602 are perpendicular to the magnetization directions of the first and second AP layers 744, 748 of the SFL TMR reader 704. The free layer 710 of the SFL TMR reader 704 has a perpendicular magnetization direction to the free layer 610 of the SFL reader 602.

The first reader 602 and the second reader 704 are two readers using different technologies. The free layer 610 is biased by the SB side shields 612a, 612b longitudinally for perpendicular or out-of-plane field detection. The second reader 704 utilizes the free layer 710 for in-plane field sensing, as the AFM layer 740 is pinned along the longitudinal or cross-track direction, and the free layer 710 is biased along the transverse direction through the RHB structure 726. Thus, the read head 700 can read both out-of-plane and in-plane magnetic fields. While not shown, the first reader 602 may be disposed over the second reader 704, like the read head 301 of FIG. 4C.

FIG. 8C illustrates a cross-sectional view of a read head 801, according to another embodiment. The read head 801 may be a part of the magnetic media drive 100 of FIG. 1. The read head 801 may be a part of the read/write head 200 of FIG. 2, such as the read head 211. The read head 801 may be the read head described in FIGS. 3A-3B. The read head 801 may be a part of the magnetic media drive 100 of FIG. 1. The read head 801 may be a part of the read/write head 200 of FIG. 2, such as the read head 211.

The read head 801 may be the read head described in FIGS. 3A-3B. The read head 801 is similar to the read head 800 of FIGS. 8A-8B; however, the AFM layer 740 is optionally recessed from the MFS by a shield notch 752, and the AFM layer 640 is optionally recessed from the MFS by a shield notch 652. As such, the AFM layer 640 and/or the AFM layer 740 may be recessed from the MFS.

Therefore, by utilizing the above described read heads, both in-plane and out-of-plane data can be read and decoded by the read heads. Moreover, strong SNR is maintained, and MRR increase is on to either reader of the read heads.

In one embodiment, a read head comprises a first sensor, the first sensor being one of: (A) a first reader comprising: a first spin orbit torque (SOT) layer disposed at a media facing surface (MFS), a free layer disposed on the SOT layer, and soft bias (SB) side shields disposed adjacent to the free layer on the SOT layer at the MFS; (B) a second reader comprising: a dual free layer (DFL) structure disposed over a shield, synthetic anti-ferromagnetic (SAF) side shields disposed adjacent to the DFL structure on the shield at the MFS, and an anti-ferromagnetic (AFM) layer disposed over the DFL structure and SAF side shields; or (C) a third reader comprising: a first AFM layer, a first anti-parallel (AP) layer disposed on the first AFM layer, a second AP layer disposed over the first AP layer, a free layer disposed over the second AP layer, and SB side shields disposed adjacent to the free layer at the MFS; and a second sensor, comprising: a SOT layer, a free layer disposed on the SOT layer, and a rear hard bias (RHB) structure disposed adjacent to the free layer, the RHB structure being recessed from the MFS.

The first sensor is the first reader. The free layer of the first reader and the free layer of the second sensor have perpendicular magnetization directions. The first sensor is the second reader. The second reader further comprises a RHB structure disposed adjacent to the DFL structure, the RHB structure being recessed from the MFS. The first sensor is the third reader. The first AP layer and the second AP layer have anti-parallel magnetization directions, and wherein the free layer has a perpendicular magnetization direction to the first and second AP layer. The free layer of the third reader and the free layer of the second sensor have perpendicular magnetization directions. A magnetic recording drive comprises the read head.

In another embodiment, a read head comprises a first sensor, the first sensor being one of: (A) a first reader comprising: a dual free layer (DFL) structure disposed over a shield, synthetic anti-ferromagnetic (SAF) side shields disposed adjacent to the DFL structure on the shield at the MFS, and an anti-ferromagnetic (AFM) layer disposed over the DFL structure and SAF side shields; or (B) a second reader comprising: a first AFM layer, a first anti-parallel (AP) layer disposed on the first AFM layer, a second AP layer disposed over the first AP layer, a free layer disposed over the second AP layer, and SB side shields disposed adjacent to the free layer at the MFS; and a second sensor comprising: a first AFM layer, a first anti-parallel (AP) layer disposed on the first AFM layer, a second AP layer disposed over the first AP layer, a free layer disposed over the second AP layer, and a RHB structure disposed adjacent to the free layer, the RHB structure being recessed from the MFS.

The first sensor is the first reader. The DFL structure of the second reader comprising a first free layer and a second free layer, the first and second free layers having finite angles pointing towards the RHB structure, and wherein the free layer of the fifth reader has a perpendicular magnetization direction to the SB side shields of the DFL structure. The first sensor is the second reader. The first and second AP layers of the third reader have anti-parallel magnetization directions, wherein the first and second AP layers of the fifth reader have anti-parallel magnetization directions, and wherein the magnetization directions of the first and second AP layers of the third reader are perpendicular to the magnetization directions of the first and second AP layers of the fifth reader. A magnetic recording drive comprises the read head.

In yet another embodiment, a read head comprises a first sensor, the first sensor being one of: (A) a first reader comprising: a dual free layer (DFL) structure disposed over a shield, synthetic anti-ferromagnetic (SAF) side shields disposed adjacent to the DFL structure on the shield at the MFS, and an anti-ferromagnetic (AFM) layer disposed over the DFL structure and SAF side shields; or (B) a second reader comprising: a first AFM layer, a first anti-parallel (AP) layer disposed on the first AFM layer, a second AP layer disposed over the first AP layer, a free layer disposed over the second AP layer, and SB side shields disposed adjacent to the free layer at the MFS; and a second sensor comprising: a first AFM layer, a first anti-parallel (AP) layer disposed on the first AFM layer, a second AP layer disposed over the first AP layer, a free layer disposed over the second AP layer, a RHB structure disposed adjacent to the free layer, the RHB structure being recessed from the MFS, and a shield notch.

The first sensor is the second reader, wherein the DFL structure of the second reader comprises a first free layer and a second free layer. The first AFM layer is recessed from the MFS by the shield notch. The first AFM layer is recessed from the MFS by the shield notch. A magnetic recording drive comprises the read head.

While the foregoing is directed to embodiments of the present disclosure, other and further embodiments of the disclosure may be devised without departing from the basic scope thereof, and the scope thereof is determined by the claims that follow.

1. A read head, comprising:
a first sensor, the first sensor being one of:
(A) a first reader comprising:
a first spin orbit torque (SOT) layer disposed at a media facing surface (MFS);
a free layer disposed on the SOT layer; and
soft bias (SB) side shields disposed adjacent to the free layer on the SOT layer at the MFS;
(B) a second reader comprising:
a dual free layer (DFL) structure disposed over a shield;
synthetic anti-ferromagnetic (SAF) side shields disposed adjacent to the DFL structure on the shield at the MFS; and
an anti-ferromagnetic (AFM) layer disposed over the DFL structure and SAF side shields; or
(C) a third reader comprising:
a first AFM layer;
a first anti-parallel (AP) layer disposed on the first AFM layer;
a second AP layer disposed over the first AP layer;
a free layer disposed over the second AP layer; and
SB side shields disposed adjacent to the free layer at the MFS; and a second sensor, comprising:
a SOT layer;
a free layer disposed on the SOT layer; and
a rear hard bias (RHB) structure disposed adjacent to the free layer, the RHB structure being recessed from the MFS.

2. The read head of claim 1, wherein the first sensor is the first reader.

3. The read head of claim 2, wherein the free layer of the first reader and the free layer of the second sensor have perpendicular magnetization directions.

4. The read head of claim 1, wherein the first sensor is the second reader.

5. The read head of claim 4, wherein the second reader further comprises a RHB structure disposed adjacent to the DFL structure, the RHB structure being recessed from the MFS.

6. The read head of claim 1, wherein the first sensor is the third reader.

7. The read head of claim 6, wherein the first AP layer and the second AP layer have anti-parallel magnetization directions, and wherein the free layer has a perpendicular magnetization direction to the first and second AP layer.

8. The read head of claim 6, wherein the free layer of the third reader and the free layer of the second sensor have perpendicular magnetization directions.

9. A magnetic recording drive comprising the read head of claim 1.

10. A read head, comprising:
a first sensor, the first sensor being one of:
(A) a first reader comprising:
a dual free layer (DFL) structure disposed over a shield;
synthetic anti-ferromagnetic (SAF) side shields disposed adjacent to the DFL structure on the shield at the MFS; and
an anti-ferromagnetic (AFM) layer disposed over the DFL structure and SAF side shields; or
(B) a second reader comprising:
a first AFM layer;
a first anti-parallel (AP) layer disposed on the first AFM layer;
a second AP layer disposed over the first AP layer;
a free layer disposed over the second AP layer; and
SB side shields disposed adjacent to the free layer at the MFS; and
a second sensor comprising:
a first AFM layer;
a first anti-parallel (AP) layer disposed on the first AFM layer;
a second AP layer disposed over the first AP layer;
a free layer disposed over the second AP layer; and
a RHB structure disposed adjacent to the free layer, the RHB structure being recessed from the MFS.

11. The read head of claim 10, wherein the first sensor is the first reader.

12. The read head of claim 11, wherein the DFL structure of the second reader comprising a first free layer and a second free layer, the first and second free layers having finite angles pointing towards the RHB structure, and wherein the free layer of the fifth reader has a perpendicular magnetization direction to the SB side shields of the DFL structure.

13. The read head of claim 10, wherein the first sensor is the second reader.

14. The read head of claim 13, wherein the first and second AP layers of the third reader have anti-parallel magnetization directions, wherein the first and second AP layers of the fifth reader have anti-parallel magnetization directions, and wherein the magnetization directions of the first and second AP layers of the third reader are perpendicular to the magnetization directions of the first and second AP layers of the fifth reader.

15. A magnetic recording drive comprising the read head of claim 10.

16. A read head, comprising:
a first sensor, the first sensor being one of:
(A) a first reader comprising:
a dual free layer (DFL) structure disposed over a shield;
synthetic anti-ferromagnetic (SAF) side shields disposed adjacent to the DFL structure on the shield at the MFS; and
an anti-ferromagnetic (AFM) layer disposed over the DFL structure and SAF side shields; or
(B) a second reader comprising:
a first AFM layer;
a first anti-parallel (AP) layer disposed on the first AFM layer;
a second AP layer disposed over the first AP layer;
a free layer disposed over the second AP layer; and
SB side shields disposed adjacent to the free layer at the MFS; and
a second sensor comprising:
a first AFM layer;
a first anti-parallel (AP) layer disposed on the first AFM layer;
a second AP layer disposed over the first AP layer;
a free layer disposed over the second AP layer;
a RHB structure disposed adjacent to the free layer, the RHB structure being recessed from the MFS; and
a shield notch.

17. The read head of claim 16, wherein the first sensor is the first reader, wherein the DFL structure of the second reader comprises a first free layer and a second free layer.

18. The read head of claim 17, wherein the first AFM layer is recessed from the MFS by the shield notch.

19. The read head of claim 16, wherein the first sensor is the second reader.

20. The read head of claim 19, wherein the first AFM layer is recessed from the MFS by the shield notch.

21. A magnetic recording drive comprising the read head of claim 16.
